(19) United States
(12) Patent Application Publication
(10) Pub. No.: US 2010/0206772 A1
(43) Pub. Date: Aug. 19, 2010

(54) Process for the fractionation of diluted bitumen for use in light sweet refinery

(75) Inventor: Dennis W. Keppers, Findlay, OH (US)

Correspondence Address: EMCH, SCHAFFER, SCHAUB & PORCELLO CO, P O BOX 916, ONE SEAGATE SUITE 1980, TOLEDO, OH, 43697, US

(73) Assignee: Marathon Petroleum Company LLC

(21) Appl. No.: 12/378,671

(22) Filed: Feb. 18, 2009

(51) Int. Cl. C10G 1/00; B01J 19/00

(52) U.S. Cl. 208/85; 422/187

(57) ABSTRACT

This is a unique way of upgrading an existing refinery to process heavy bitumen. The upgrade utilizes a diluent recovery unit (DRU) in front of a Resid Hydrocracker. The diluent is light enough that the DRU does not require significant metallurgy upgrades. The corrosive, heavier material is neutralized in the Resid Hydrocracker eliminating need for metallurgical upgrades in downstream units.

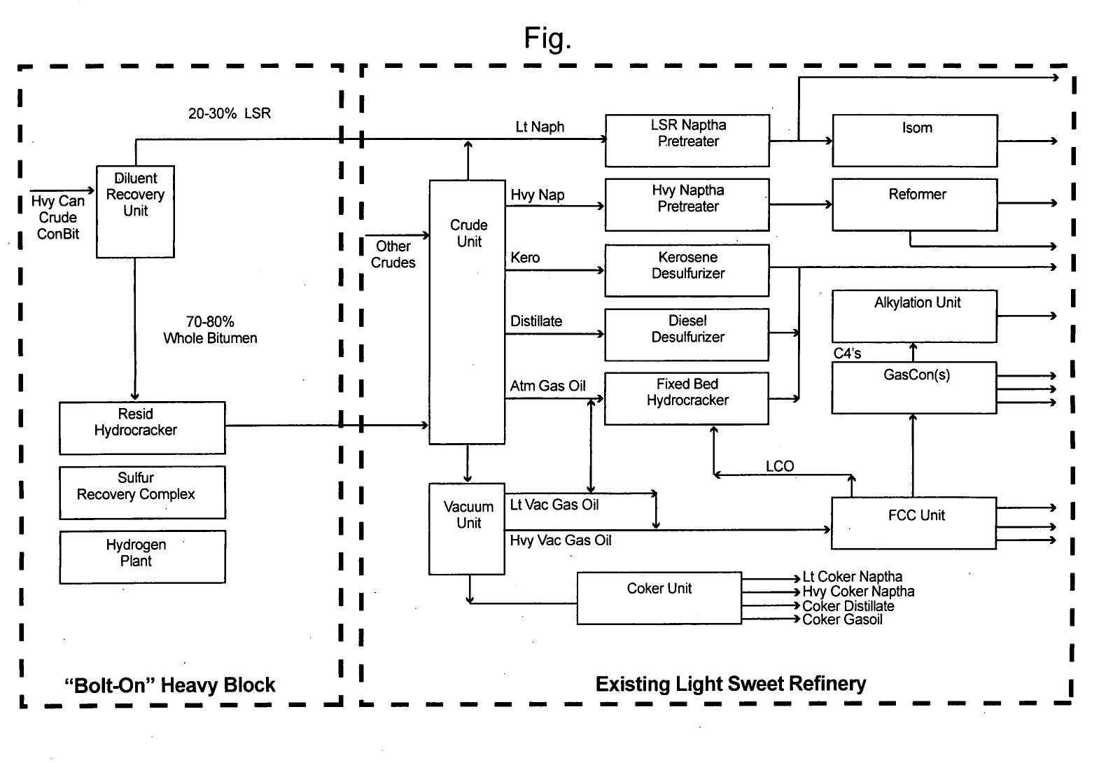

### TECHNICAL FIELD OF THE INVENTION

This invention relates to the combination of a diluent recovery unit with Resid Hydrocracker. More specifically, the combination processes a blend of heavy bitumen and a light diluent for use in a light sweet refinery.

### BACKGROUND OF THE INVENTION

Extensive reserves in the form of “heavy crudes” exist in a number of countries, including Western Canada, Venezuela, Russia, the United States, and elsewhere. These deposits of heavy crudes often exist in areas that are inaccessible by normal means. Generally, the term “heavy crude” refers to a hydrocarbon material having an API gravity of less than 25.

Oil and sand is a thick, viscid mixture of bitumen, sand, clay and water that resembles asphalt to the untrained eye. “ConBits” are produced by blending heavy bitumen with a light diluent (e.g. condensate, naphtha or natural gasoline) to reduce the viscosity for pipeline specifications. The bitumen is often corrosive requiring significant metallurgy upgrades in refinery Crude, Vacuum, and other downstream processing units.

It can cost billions of dollars to upgrade a refinery to process heavy bitumen. There are concerns that the costs of converting refineries to process heavy bitumen will be hard to recoup. Long term, the ability to use heavy bitumen is an issue that's expected to confront the refining industry for an extended period of time.

### SUMMARY OF THE INVENTION

Rather than requiring extensive Crude and Vacuum unit, metallurgy upgrades to process a Heavy Crude ConBit, we have invented a unique way of processing ConBits to avoid such equipment requirements.

This invention utilizes a diluent recovery unit (DRU) in front of a Resid Hydrocracker. The diluent is light enough that the DRU does not require significant metallurgy upgrades. The DRU does not require metallurgy upgrades because the corrosive organic acids are not a concern at its lower operating temperatures (e.g. below 450° F.). The corrosive, heavier material is neutralized in the Resid Hydrocracker eliminating need for metallurgical upgrades in downstream units.

Other objects and advantages of the present invention will become apparent to those skilled in the art upon a review of the following detailed description of the preferred embodiments and the accompanying drawings.

### BRIEF DESCRIPTION OF THE DRAWINGS

The FIG. is a block diagram of a diluent recovery unit and a resid hydrocracker according to this invention in combination with a typical existing sweet refinery.

### DETAILED DESCRIPTION OF THE INVENTION

This invention is a fractionation and hydrotreating process and apparatus for upgrading heavy hydrocarbonaceous feedstock of heavy oil without significant metallurgy requirements. The process comprises the steps of providing a blend of the heavy hydrocarbonaceous feedstock and a light diluent; feeding the blend to a diluent recovery unit (DRU); and removing the light diluent from the heavy hydrocarbons feedstock in the DRU. Next the heavy hydrocarbonaceous feedstock is recovered from the DRU and fed to a Resid Hydrocracker. The recovered hydrocarbonaceous feedstock is no longer corrosive.

The light solvent typically is C₃-C₇ hydrocarbon solvent, selected from the group consisting of hydrocarbon solvents having 3-7 carbon atoms and mixtures thereof. Preferably, the light solvent is naphtha. The Resid hydrocracker is conventional and the existing refinery is an existing sweet refinery.

The FIG. is a block diagram of a diluent recovery unit and a resid hydrocracker according to this invention in combination with a typical existing sweet refinery. Heavy Canadian crude and a light solvent are fed to the DRU unit. Light naptha is recovered from the DRU and fed to a preheater in the existing refinery. Heavy hydrocarbonaceous feedstock is recovered from the DRU and fed to a Resid Hydrocracker. The recovered hydrocarbonaceous feedstock is no longer corrosive. A recovered lowered boiling point hydrocarbonaceous feedstock from the Resid unit is fed to a primary fractionation tower in an existing refinery.

During resid hydrotreating, resid oil is upgraded with hydrogen and a hydrotreating catalyst to produce more valuable lower-boiling liquid products.

Conventional resid hydroprocessing systems typically include one or more reactors that comprises a reaction chamber, a port at the bottom of the reaction chamber through which a heavy oil feedstock and pressurized hydrogen gas are introduced, a port at the top of the reaction chamber through which fresh catalyst is introduced, a recycle cup and conduit in the center of the reaction chamber, an expanded catalyst zone, an ebullating pump that circulates the reactor liquid down through the recycle cup and conduit and up through the expanded catalyst zone, a first catalyst free zone at the reactor bottom (or plenum), a second catalyst free zone above the expanded catalyst zone, a port at the top of the reaction chamber through which an upgraded feedstock is withdrawn from the second catalyst free zone, and a port at the bottom of the reaction chamber through which spent catalyst is withdrawn. Circulation of the heavy oil feedstock upwards through the expanded catalyst zone maintains the solid supported catalyst in and expanded, or fluidized state. It also helps equalize the temperature of the feedstock throughout the reaction chamber.

The resid hydrocracker reactor typically operates with a hydrogen partial pressure between 1000 and 3000 psig and a temperature between 370 and 470° C. A fixed-bed, down-flow resid hydrotreater reactor may be employed at the lower range of these temperatures (about 370 to 425° C.). The heavy oil residence time in the resid hydrocracker reactor is adjusted such that the quantity of hydrogen added to the oil meets or exceeds the requirements of the subsequent hydrogen donor cracking process step. The residence time is typically about 5 to 60 minutes.

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

I claim:

1. A fractionation and hydrotreating process for reducing the metallurgy requirements to process a heavy hydrocarbonaceous feedstock of heavy oil or heavy bitumen comprising the steps of:
providing a blend of the heavy hydrocarbonaceous feedstock and a light diluent;
feeding the blend to a diluent recovery unit (DRU);
removing the light diluent from the heavy hydrocarbons feedstock in the DRU;
recovering the heavy hydrocarbonaceous feedstock from the DRU;
feeding the recovery hydrocarbonaceous feedstock to a Resid Hydrocracker;
recovering a hydrocarbonaceous feedstock having eliminated the corrosive components from the Resid Hydrocracker; and
feeding the recovered lowered boiling point hydrocarbonaceous feedstock from the Resid Hydrocracker to an existing refinery.

2. A process according to claim 1 wherein the heavy hydrocarbonaceous feedstock is a heavy bitumen resulting from de-asphalting oil sand.

3. A process according to claim 1 wherein the light solvent is C₃-C₇ hydrocarbon solvent, selected from the group consisting of hydrocarbon solvents having 3-7 carbon atoms and mixtures thereof.

4. A process according to claim 1 wherein the light solvent is naphtha.

5. A process according to claim 1 wherein the existing refinery is an existing sweet refinery.

6. A fractionation and hydrotreating apparatus for reducing the metallurgy requirements to process a heavy hydrocarbonaceous feedstock of heavy oil or heavy bitumen comprising:
a diluent recovery unit (DRU);
a means for providing a blend of the heavy hydrocarbonaceous feedstock and a light diluent to the DRU;
a means for removing the light diluent from the heavy hydrocarbons feedstock in the DRU;
a means for recovering the heavy hydrocarbonaceous feedstock from the DRU;
a Resid hydrocracker;
a means for feeding the recovered hydrocarbonaceous feedstock from the DRU to the Resid hydrocracker;
a means for recovering a hydrocarbonaceous feedstock having eliminated the corrosive components from the Resid hydrocracker; and
a means for feeding the recovered lowered boiling hydrocarbonaceous feedstock from the Resid hydrocracker, to an existing refinery.

7. An apparatus according to claim 6 wherein the existing refinery is an existing sweet refinery.
